(19) United States
(12) Patent Application Publication
(10) Pub. No.: US 2026/0062205 A1
(43) Pub. Date: Mar. 5, 2026

(54) HOPPER FOR A CEMENT OR MORTAR PRINTER

(71) Applicant: MIGHTY SEAWALL INC., Miami, FL (US)

(72) Inventors: Arnold Flores, Miami, FL (US); Diego Sarmiento Mejia, Miami, FL (US); Imran Adamjee, Miami, FL (US)

(21) Appl. No.: 19/312,855

(22) Filed: Aug. 28, 2025

Related U.S. Application Data
(60) Provisional application No. 63/688,392, filed on Aug. 29, 2024.

(51) Int. Cl. B65D 88/72; B28B 1/00; B28B 13/02; B33Y 40/00; E04G 21/02

(52) U.S. Cl. CPC B65D 88/72; B28B 1/001; B28B 13/02; B33Y 40/00; E04G 21/02

(57) ABSTRACT

A fluidization system for fluidizing granular material within a hopper has a frame configured to be disposed against and supported by an interior of a hopper in a substantially horizontal orientation. The frame forms a gas conduit and a plurality of fluidization pipes are in fluid communication with the frame. The fluidization pipes extend from the frame at an angle relative to the frame and each fluidization pipe has at least one opening, so there is a fluid pathway being formed from the conduit to the opening.

### BACKGROUND OF THE INVENTION

The present invention is directed to a hopper for a printer for printing a seawall and more particularly to a hopper for feeding the raw fine grain material into the printer.

It is well known in the art to print objects such as prefab houses, art, even seawalls from concrete, cement or mortar with large in situ printers, herein collectively “cement printers”. The raw materials, such as fine mortar, are fed into the printer on a continuous basis, either by pouring the material into the cement printer bag by bag or by using a hopper.

A hopper, as known in the art, is a conically shaped structure that funnels raw material at a specific volume feed rate to a desired location. In normal operation the materials decrease in volume at a constant rate until the hopper is empty. Given the size of the items being printed, a cement printer must be brought to the manufacture site. As a result, cement printers operate in environments that do not have controlled conditions.

While prior art printers may sometimes perform satisfactorily, they suffer from the disadvantage that many factors impact the operation of the hopper. The type of material being dispensed playing the biggest role. For example, when hygroscopic materials such as fine grain mortar are used, the weather can affect hopper operation. As seen in FIG. 1A, material 20 disposed in a hopper 10 desirably flows from hopper 10 in a relatively uniform manner until no more material is left. However, in a more humid environment, the mortar flow changes.

In FIGS. 1B and 1C, like numerals indicate like structure. In FIG. 1B, mortar 20 does not flow evenly and exhibits bridging resulting in an arch 22 which hinders or prevents the flow of mortar 20. FIG. 1C illustrates “ratholing” in which a rathole 24 develops in mortar 20, leaving significant amounts of material in the hopper 10 and unprinted.

Remedies for these problems are known in the art. For example, the hopper 10 can be situated in a climate-controlled or humidity controlled environment. Additionally, the material would preferably also be stored in the same environment. However, this solution is costly and impractical for in-situ manufacture. Another approach is to vibrate the hopper 10. Vibrators may be bolted on the walls of the hopper 10 and turned on periodically to loosen the material from the sides of the hopper 10. This solution has been satisfactory; however, it suffers from the disadvantage of requiring additional wall maintenance and complexity of building structure and attendant maintenance.

Reference is made to FIG. 2 in which a second prior art structure for solving the material flow problem is provided. The introduction of compressed air into hopper 10 is performed to introduce compressed air bursts to specified locations within hopper 10 resulting in the fluidization of the material 20 to preventing arching and ratholing. By way of non-limiting example, a fluidization pad such as a Solimar pad 14 is disposed on an interior surface of hopper wall 12 of hopper 10. An air conduit 16 is attached to or part of the Solimar pad 14 and mounted within the pad 14 for guiding air under pressure from pad 14 in a number of directions. A compressed air pipe 18 disposed on the exterior of wall 12 is in fluid communication with air conduit 16. Bursts of compressed air flow through air pipe 18 in the direction of arrow C to air conduit 16 and cause pad 14 to vibrate and release the air along the hopper wall 12 outward, such as in the direction of arrows A and B and/or in a number of directions.

This solution has been satisfactory for some issues, but suffers from the disadvantage that fluidization pads such as Solimar pads 14 are costly and require permanent modifications to hopper walls 12. The modifications may affect the integrity of the hopper 10 or the ability for the hopper 10 to be used for other materials.

Accordingly, a system which overcome the shortcomings of the prior art is desired.

### SUMMARY OF THE INVENTION

A fluidization system for fluidizing material within a hopper includes a frame. The frame is configured to be disposed against and supported by an interior of a hopper in a substantially horizontal orientation. The frame forms a gas conduit. A plurality of pipes are each in fluid communication with the frame. Each pipe extends from the frame at an angle relative the frame. Each pipe is formed with at least one opening therein, the at least one opening facing into the interior of the hopper. A fluid pathway is formed from the conduit to the opening.

In one embodiment of the invention, each pipe of the plurality of pipes is separated from an adjacent pipe of the plurality of pipes by about ninety degrees.

In another embodiment of the invention at least one pipe of the plurality of pipes extends along a wall of the hopper.

### BRIEF DESCRIPTION OF THE DRAWINGS

The features and advantages of the present invention will become more readily apparent from the following detailed description of the invention in which like elements are labeled similarly and in which:

FIGS. 1A-1C are sectional views of hoppers functioning in accordance with prior art hoppers;

FIG. 2 is a sectional view of a prior art structure for solving agglomeration of the material within the hopper; and

FIG. 3 is a top plan view of a hopper constructed in accordance the invention.

FIG. 4 is a side view of the interior side surface of a hopper constructed in accordance the invention.

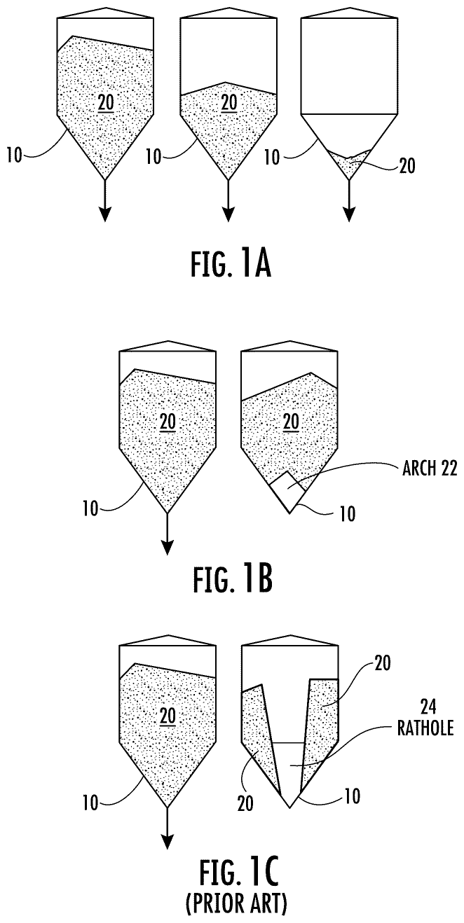

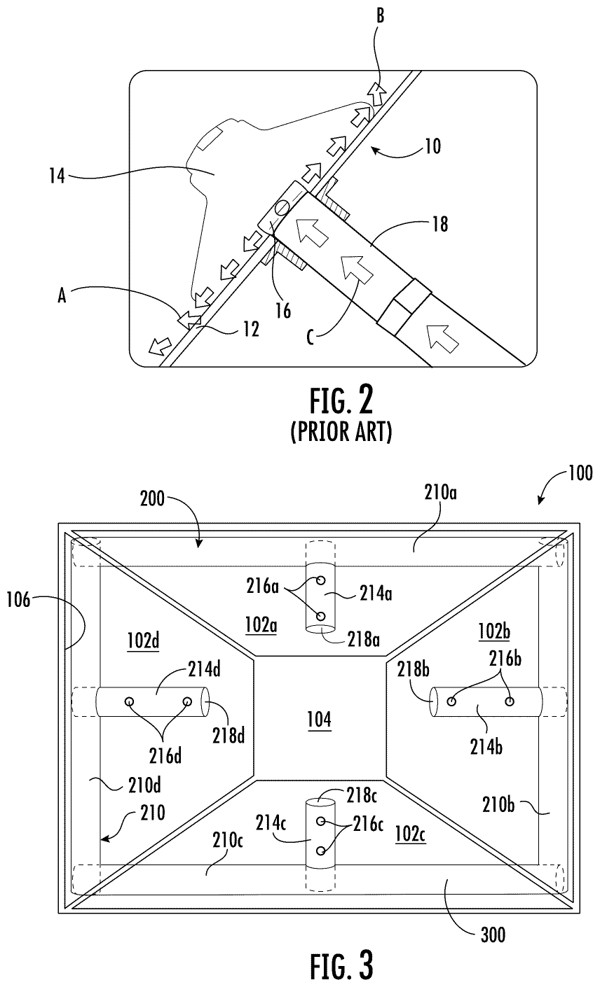

### DETAILED DESCRIPTION OF THE INVENTION

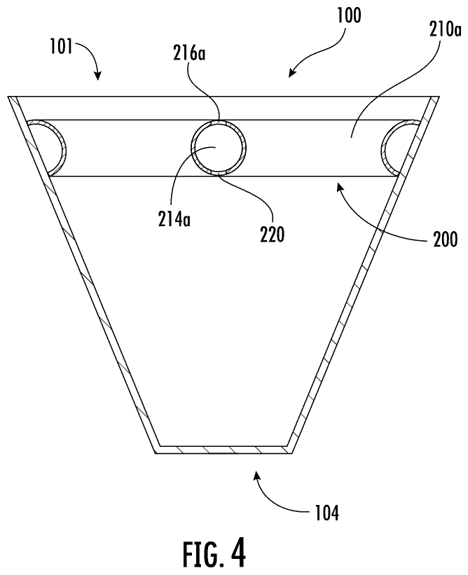

Reference is now made to FIGS. 3 and 4 in which a hopper 100, shown as a four paneled tetrahedron, in one nonlimiting example, has four walls 102a-d, formed as four plane triangular faces, having a top opening 101 receiving materials (“receiving end”), and a bottom opening 104 for dispensing materials (“dispensing end”). As shown the top opening 101 and the bottom opening 104 are quadrilateral in shape; however, other shapes (polygon, oval, irregular) as may be needed are also contemplated.

As shown in FIG. 3, the fluidization system 200 includes a frame 210, which in one nonlimiting embodiment is disposed against, and supported by, interior walls 102a-102d of hopper 100 placed in a vertical orientation. The frame 210 may be supported by friction (as indicated in the drawing), connectors to the interior of the hopper 100 or support elements attached to the hopper 100. Thus, the frame 210 lies across walls 102a-102d. Frame 210 is hollow to enable fluid to flow therethrough. More particularly, frame 210 is formed as a pipe frame having interconnected frame pipes 210a-210d each successively connected to each other in fluid communication to form the fluid flow path of frame 210. In a preferred, non-limiting embodiment, frame 210 is a rectangle dimensioned to rest against, and be supported by, an interior of hopper 100 between the top opening 101 and bottom opening 104. In other words, frame 210 has a perimeter sized between a circumference of top opening 101 and a circumference of the bottom opening 104. However, frame 210 can be any shape that lends itself to being sized to fit within the hopper 100 and rest against, and be supported by, one or more interior walls of the hopper 100 at a position between the top opening 101 and bottom opening 104. Alternatively, the hopper may be shaped conically.

As shown in FIG. 3, a plurality of fluidization pipes 214a-214d is each in fluid communication with a respective frame pipe 210a-210d. While four fluidization pipes are illustrated, there may be one or more walls without a fluidization pipe, and there may be more than one fluidization pipe on a selected frame pipe.

More particularly, a fluidization pipe 214a extends at an angle from, and is in fluid communication with, a frame pipe 210a of frame 210. A fluidization pipe 214b extends at an angle from, and is in fluid communication with, a frame pipe 210b of frame 210. A fluidization pipe 214c extends at an angle from and is in fluid communication with a frame pipe 210c of frame 210. A fluidization pipe 214d extends at an angle from and is in fluid communication with a frame pipe 210d of frame 210. In this way there is a gas flow path from frame 210 through fluidization pipes 214a-214d. The angle of the fluidization pipe may be preferred to be 90 degrees as shown in FIG. 3. However, the angle may be more or less than 90 degrees. Moreover, the angle may extend upwards, downwards or laterally in any direction.

As shown in FIG. 3, a fluidization pipe 214a-214d is formed with one or more respective holes 216a-216d as openings in the pipe. Each fluidization pipe 214a-214d is preferably closed ended at the end away from frame 210 so that each fluidization pipe 214a-214d has a respective cap 218a-218d. The closed end may be a cap placed on the end of the fluidization pipe or may be formed as part of the fluidization pipe. In this way, pressurized air flows through holes 216a-216d.

A fluid flow path is formed through frame 210, through respective fluidization pipes 214a-214d and through holes 216a-216d. In a preferred non-limiting embodiment respective fluidization pipes 214a-214d are spaced from each other by about ninety degrees about the interior of hopper 100. In a preferred, non-limiting embodiment fluidization pipes 214a-214d extend towards the interior of hopper 100 away from the walls, and holes 216a-216d face in a direction so as not to be blocked by walls of hopper 100. Furthermore, while only holes 216a-216d are shown for ease of description, additional holes may be disposed at different positions about the circumference of fluidization pipes 214a-214d. As shown in FIG. 4, a hole 216a may be on a top side of a fluidization pipe 214a. Alternatively, a hole 220 may be on a bottom side of the fluidization pipe 214a, or on any side of a fluidization pipe. Additionally, in a preferred non-limiting embodiment, fluidization pipes 214a-214d extend at the same angle as the sides of the hopper. In one non-limiting embodiment, the pipes 214a-214d may be in contact with and along the sides of the hopper 100.

During use, compressed gas such as air is introduced to frame 210 and flows through each of frame pipes 210a-210b through an entrance 300 in the frame 210. The compressed gas flows through each of fluidization pipes 214a-214d, and out through holes 216a-216d into the interior of hopper 100. The entrance 300 may be separate from the hopper 100 as shown in FIG. 3 or the compressed gas may be piped through the surface of the hopper 100. Hoppers generally haves existing holes on their side including load sensors or auger holes. These existing holes may be ideal places to introduce gas such as air to frame 210 in accordance with the invention. The introduction of compressed air into the powdered material causes the material to behave like a fluid (fluidization). The fluidization prevents arching and ratholing of the material in humid environments.

It is also to be understood that the following claims are intended to cover all of the generic and specific features of the invention herein described, and all statements of the scope of the invention which, as a matter of language, might be said to fall there between.

What is claimed is:

1. A fluidization system for fluidizing granular material within a hopper, comprising:
a frame configured to be disposed against and supported by an interior of a hopper,
wherein the hopper is in a substantially horizontal orientation; and
wherein the frame forms a gas conduit; and
a plurality of fluidization pipes in fluid communication with the frame,
wherein each fluidization pipe extends from the frame at an angle relative to the frame,
wherein each fluidization pipe further comprises at least one opening therein,
wherein a fluid pathway is formed from the conduit to the at least one opening.

2. The system of claim 1, wherein each fluidization pipe further comprises a closed end at the portion distant from the frame.

3. The system of claim 1, further comprising a source of compressed gas in fluid communication with the fluid pathway.

4. The system of claim 1, wherein the at least one opening of each fluidization pipe further is located on one of a top portion, a bottom portion and a side portion of the fluidization pipe.

5. The system of claim 1, wherein the frame has a polygon shape, and a fluidization pipe is located on each side of the polygon.

6. An apparatus for fluidizing granular material within a hopper, comprising:
a hopper, and
a frame configured to be disposed against and supported by an interior of the hopper,
wherein the hopper is in a substantially horizontal orientation; and
wherein the frame forms a gas conduit; and
a plurality of fluidization pipes in fluid communication with the frame,
wherein each fluidization pipe extends from the frame at an angle relative to the frame,
wherein each fluidization pipe further comprises at least one opening therein,
wherein a fluid pathway is formed from the conduit to the at least one opening.

7. The apparatus of claim 6, further comprising a source of compressed gas in fluid communication with the fluid pathway.
